(19) United States
(12) Patent Application Publication
(10) Pub. No.: US 2008/0244541 A1
(43) Pub. Date: Oct. 2, 2008

(54) CODE TRANSLATOR AND METHOD OF AUTOMATICALLY TRANSLATING MODELING LANGUAGE CODE TO HARDWARE LANGUAGE CODE

(75) Inventors: Robert John Thomson, Dover (GB); Vassilios Chouliaras, Leicestershire (GB); David Mulvaney, Leicestershire (GB); Ashwin Kumar Kumaraswamy, Bangalore (IN); Ramalingam Kannan, Haryana (IN)

Correspondence Address: FULBRIGHT & JAWORSKI L.L.P, 2200 ROSS AVENUE, SUITE 2800, DALLAS, TX, 75201-2784, US

(73) Assignee: Loughborough University Enterprises Limited, Leicestershire (GB)

(21) Appl. No.: 11/962,856

(22) Filed: Dec. 21, 2007

(30) Foreign Application Priority Data
Dec. 21, 2006 (GB) 0625451.0

(51) Int. Cl. G06F 9/45

(52) U.S. Cl. 717/143

(57) ABSTRACT

The present invention provides a method of automatically translating modeling language code to hardware language code and a code translator. The modeling language code is parsed to extract values associated with predetermined ones of a plurality of constructs to generate parsed modeling language code; and a transformation block is applied to the parsed modeling language code. The transformation block is adapted to convert the parsed modeling language code into hardware language code.

### CROSS-REFERENCE TO RELATED APPLICATIONS

The present application claims priority from Great Britain Patent Application No 0625451.0 filed on 21 Dec. 2006 and from U.S. patent application Ser. No 11/825,341 filed on 6 Jul. 2007, the contents of which are incorporated herein by reference.

### TECHNICAL FIELD

Embodiments of the present invention relate to computer code translation. In particular, they relate to methods and apparatus for automated translation of modeling language code, such as XMI, to a hardware language code.

### BACKGROUND OF THE INVENTION

The user interface for computer program design may be operated through a UML (unified modeling language) application that provides an export of its diagrams in XMI form. Typical diagram types are: class, activity, state transition and collaboration, an example of this can be found in the UML specification (http://www.uml.org).

UML allows a user's design to be represented in an object-oriented manner. The design is depicted in terms of classes that contain data (attributes) and the operations (methods) that can be performed on the data.

A class diagram defines the attributes that classes can store and the methods that operate on that data. The class diagram also shows interrelationships between classes. An activity diagram describes the sequence of methods that are called in order to perform a required operation. State transition diagrams show how the execution of the methods (that in turn modify attributes) will move the system from one state to another. Each state corresponds to a specific set of values taken by the attributes in a class. A collaboration diagram shows all the possible method calls that can take place within or between classes.

XMI (XML metadata exchange) is based on XML (extensible markup language), a format commonly used to describe structured data and its meaning in a portable fashion. The specification of XMI has been proposed by the OMO (object modeling group) standards body as a set of metamodels for representing the structured data contained in UML diagrams.

System level design languages (SLDLs) are generally built on existing languages such as C, C++ or Verilog, but with extensions that allow them to be better used for hardware description. An SLDL extends the high-level language to permit the description of one or more of the following: logic modules, hardware states, inputs and outputs, communication, synchronization, timing and concurrency. The SLDL includes constructs that allow the description of electronic hardware, or both hardware and software. A construct is a systematically arranged sentence containing a grammatically correct arrangement of terms. In a computer program it is a syntactically correct section of code that satisfies the specification of the language. Only syntactically correct code can be successfully compiled.

Hardware description languages (HDLs) are design-entry languages used as part of the electronic design automation process for generating digital circuits. Examples of HDLs are VHDL (very high-speed hardware description language) and Verilog.

We define the term ‘hardware language’ (HL) to include both SLDLs and HDLs

The description provided in an HL can be used to verify the hardware description and the operating times of the modules in the proposed hardware implementation.

### BRIEF SUMMARY OF THE INVENTION

The present invention is directed to a system and method which would be desirable to provide for the automated translation of modeling language code to hardware language (HL) code.

According to a first aspect of the present invention, there is provided a method of automatically translating modeling language code to hardware language code comprising: parsing the modeling language code to extract values associated with predetermined ones of a plurality of constructs to generate parsed modeling language code; and applying a transformation block to the parsed modeling language code, wherein the transformation block is adapted to convert the parsed modeling language code into hardware language code.

According to a second aspect of the present invention, there is provided a code translator for automatically translating modeling language code to hardware language code the translator comprising: a parsing block adapted to parse the modeling language code to extract values associated with predetermined ones of a plurality of constructs; and a transformation block adapted to convert the parsed modeling language code into hardware language code.

According to a third aspect of the present invention, there is provided apparatus comprising the aforementioned code translator and a circuit fabricator adapted to determine the structure of an electronic circuit corresponding to the hardware language code from the hardware language code and fabricate the electronic circuit.

According to a fourth aspect of the present invention, there is provided a record medium embodying a computer program having computer program instructions executable for: parsing modeling language code to extract values associated with predetermined ones of a plurality of constructs; and converting the parsed modeling language code to hardware language code.

According to a fifth aspect of the present invention, there is provided a method of automatically translating modeling language code to HL code comprising: parsing the modeling language code to extract values associated with predetermined ones of a plurality of constructs; and populating, in a predetermined manner using the extracted values, empty fields of one or more predetermined templates wherein the or each template comprises code of the HL.

According to a sixth aspect of the invention, there is provided a code translator for automatically translating modeling language code to HL code, the translator comprising: a parsing block for parsing the modeling language code to extract values associated with predetermined ones of a plurality of constructs; and a transformation block for populating, in a predetermined manner using the extracted values, empty fields of one or more predetermined templates wherein the or each template comprises code of the HL.

According to a seventh aspect of the present invention, there is provided a record medium embodying a computer program having computer program instructions for: parsing the modeling language code to extract values associated with predetermined ones of a plurality of constructs; and populating, in a predetermined manner using the extracted values, empty fields of one or more predetermined templates wherein the or each template comprises code of the HL.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 schematically illustrates a system for translating an XMI symbolic description such as UML into an HL language description in a two stage process according to one embodiment of the present invention;

FIG. 1a schematically illustrates a system for translating an XMI symbolic description such as UML into an HL language description according to an alternative embodiment of the present invention;

FIG. 2 illustrates a user interface of a UML tool used in conjunction with the present invention;

FIG. 2A illustrates a portion of an XMI document produced from the UML tool of FIG. 2;

FIG. 2B illustrates a UML class diagram;

FIG. 3 illustrates an example of a structured data format (Parsed XMI);

FIG. 4 illustrates a portion of a template for generating syntactically correct HL output;

FIG. 5 illustrates the results of applying SystemC SLDL templates to each class and interface in the parsed XMI code illustrated in FIG. 4; and

FIG. 6 shows a software implementation in which a computer system uses computer program instructions to operate as a translator.

### DETAILED DESCRIPTION OF THE INVENTION

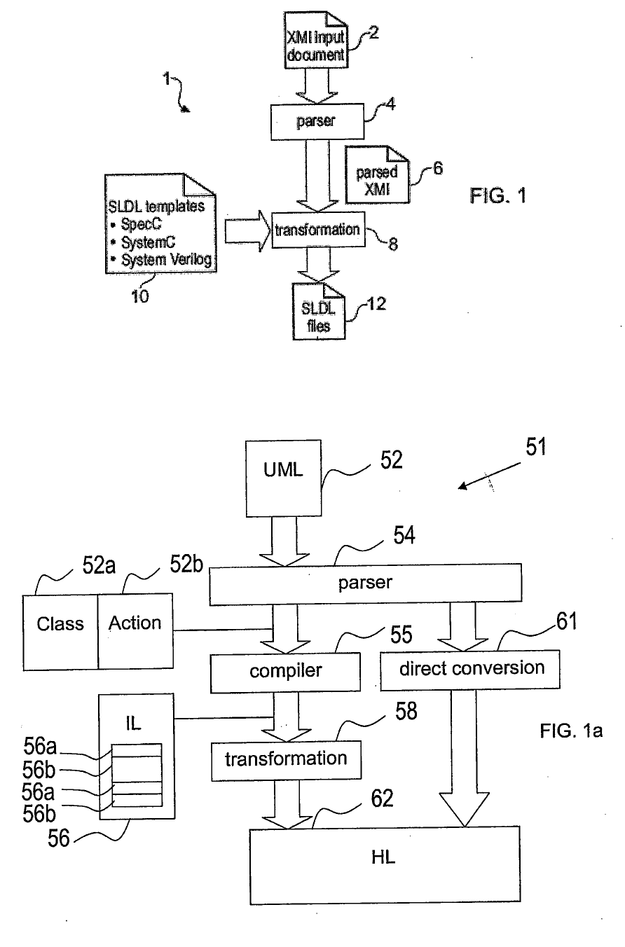

As illustrated in FIG. 1, in one embodiment of the invention, an XMI symbolic description 2 (such as UML) is translated by a translator 1 into an HL language description 12 in a two stage process. First, the XMI input document data structure 2 is parsed by parser block 4 to produce parsed XMI data structure 6, then with the aid of an appropriate template 10, the parsed XMI data structure 6 is converted by transformation block 8 to HL code data structure 12.

The translator 1 is designed as computer implemented modules or blocks. The front-end parser block 4 electronically converts the XMI data structure 2 from a particular UML application into a standard parsed XMI format 6. Parsed XMI 6 is a new intermediate format defined by the inventors that is independent of the UML package that actually generated the XMI 2 and is independent of the target HL 12. A different front-end parser module 4 may be necessary for each UML application, but the standard parsed XMI 6 remains in the same format. The parsed XMI contains the relevant information extracted from the XMI. Typically a large percentage (90% or more) of the XMI content is superfluous, it being a rather verbose description containing irrelevant information regarding how to redraw the UML diagram.

A back-end transformation block 8 electronically converts the standard parsed XMI format into a particular HL language. A different back-end module 8 will be necessary for each HL, but the input to the back-end module, the standard parsed XMI 6, remains in the same format. A desired back-end transformation block 8 can be created by loading the appropriate set of templates 10. There will typically be a different set of templates 10 for each HL.

The input to the parser block 4 is an XMI document or documents 2. This will be electronically parsed as a whole in a single pass through. The output of this block 4 is parsed XMI 6.

An alternative embodiment of the invention is illustrated in FIG. 1a, in which an XMI symbolic description 52 (such as UML) is translated by an alternative translator 51 into an HL language description 62 in a two stage process. In this embodiment, the XMI symbolic description 52 comprises class code 52a and action code 52b. The class code 52a is code which is representative of characteristics and/or variables of data which are to be processed in the resultant hardware, whereas the action code 52b is representative of methods which can be performed on the data. The action code 52b is formed as a high-level action/method based language, such as C++, and is contained in the XMI symbolic description as tagged action code associated with a particular class.

In the embodiment of FIG. 1a, the XMI input document data structure 52 is parsed by parser block 54 to separate the action code 52b from the class code 52a into separate distinct sections of the parsed code. The separate sections 52a, 52b may be interleaved with each other. The action code 52b (being in a high-level language) is compiled in complier 55 into a low-level language, such as assembly language, to produce one or more first sections 56a of intermediate language code 56. The class code 52a is parsed and separately converted in compiler 55 to one or more second sections 56b of intermediate language code 56. The first and second sections 56a, 56b of intermediate language code may be interleaved and spread throughout memory of the translator 51. The intermediate language code 56 includes all of the UML state machines and C++ method definitions from the XMI input document data structure 52.

A transformation block 58 then converts the intermediate language code 56 to HL code data structure 62 by applying behavioral synthesis to the intermediate language code 56. In one stage of converting the intermediate language code 56 to the HL language code 62, the transformation block 58 carries out scheduling on the intermediate language code 56. During scheduling, a different state is assigned and used for each section of code in the intermediate language code 56.

The translator 51 also comprises a direct conversion block 61 which is configured to convert specific structural aspects of hardware represented in the modeling language code directly into hardware language code. This can be done because the hardware features represented in the modeling language code 52 merely need to be converted into equivalent features in the hardware language code 62. The structural hardware aspects represented in the modeling language can be one or more features, such as: class diagrams, object diagrams, deployment diagrams, composite structure diagrams, components diagrams and/or stereotypes. The direct conversion block 61 might optionally utilize a template-based conversion similar to the conversion performed in the transformation block 8 in FIG. 1.

As with the embodiment of FIG. 1, the translator 51 of the embodiment of FIG. 1a is implemented via computer implemented modules or blocks. The front-end parser block 54 electronically separates the action code 52b from the class code 52a and converts this code into the intermediate language code 56. A different front-end parser module 54 may be necessary for each UML application, but the intermediate language 56 remains in the same format.

The back-end transformation block 58 electronically converts the intermediate language code 56 into a particular HL language code 62. A different back-end module 58 will be necessary for each type of HL language code 62, but the input to the back-end module 58, the intermediate language 56, remains in the same format.

In both the embodiments of FIG. 1 and FIG. 1a, the hardware language code 62 is a hardware description language, such as VHDL or Verilog or a system level design language, such as SystemC.

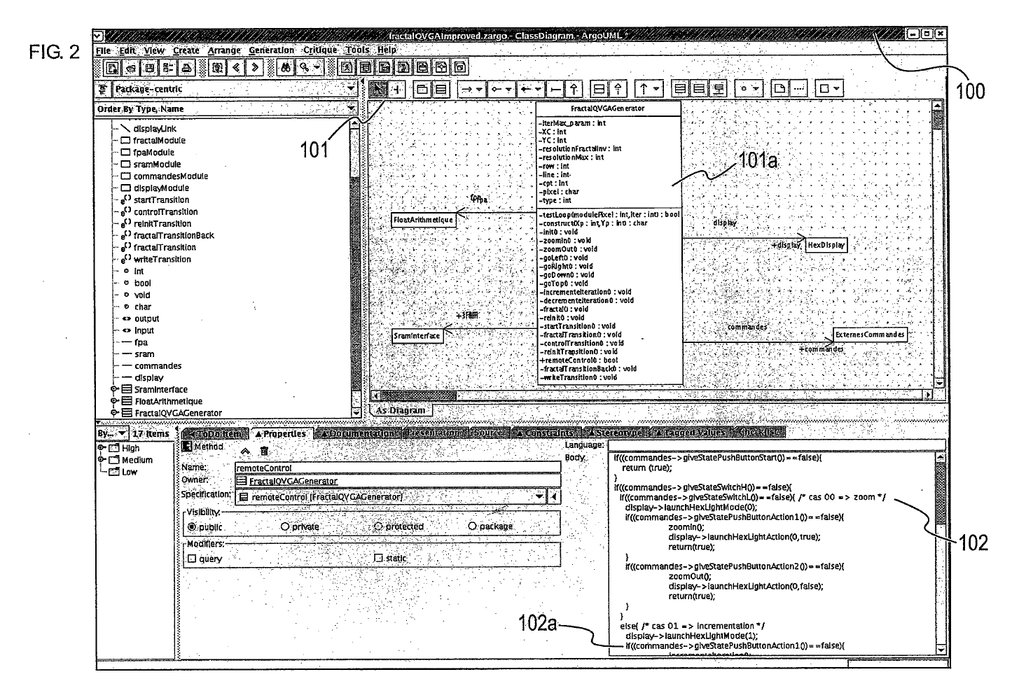

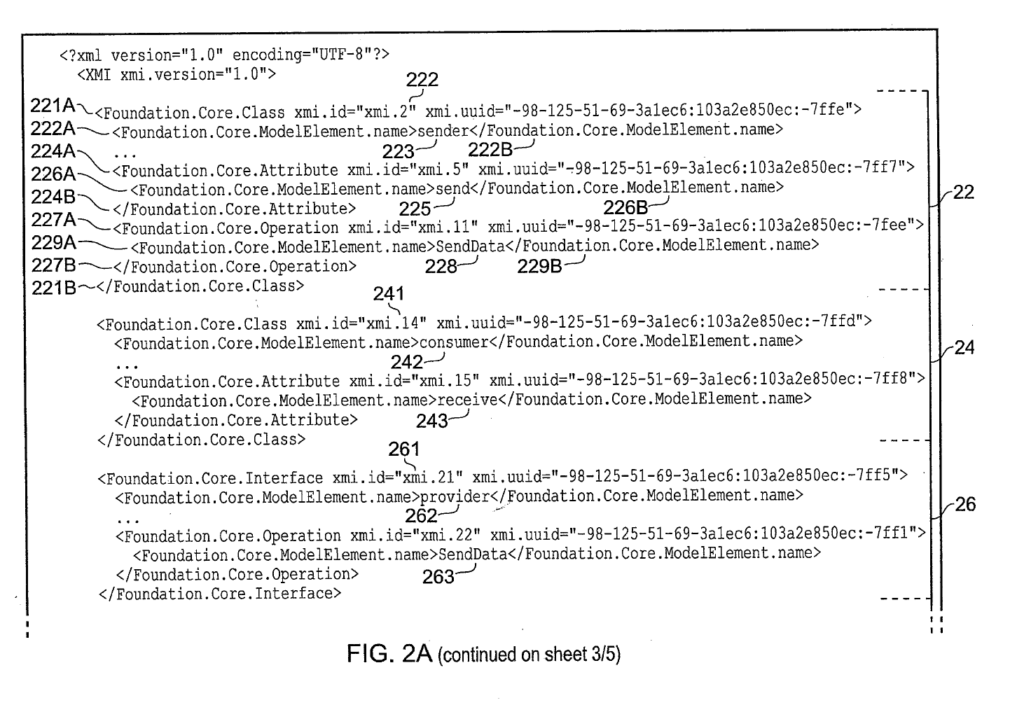

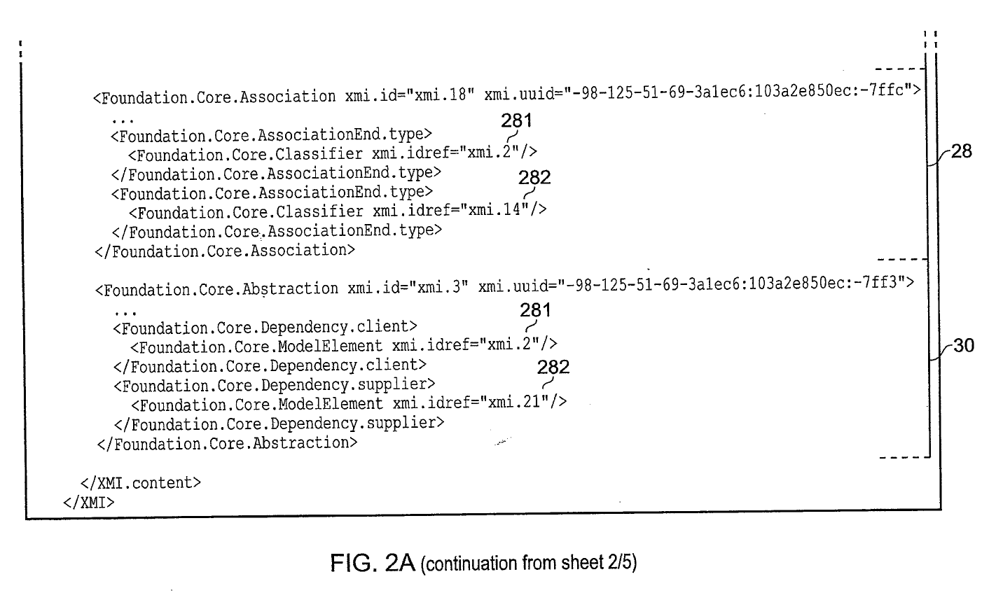

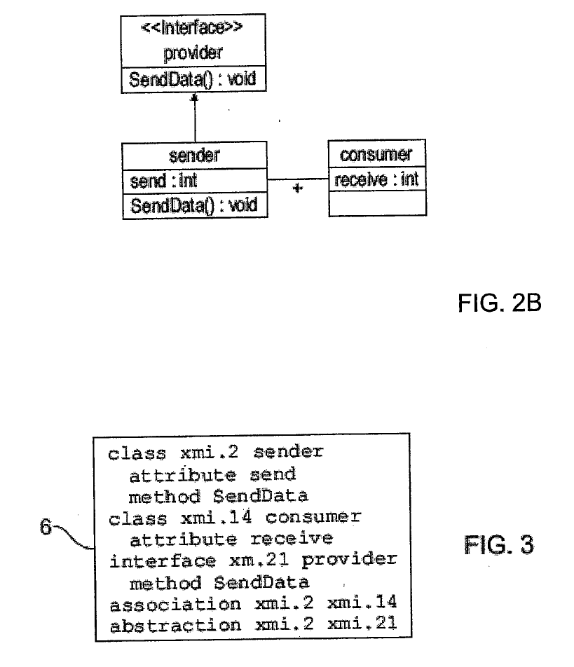

FIG. 2 is a representation of a UML tool 100 which allows a circuit designer to draw the design diagrams (that include the class, activity, state transition and collaborative diagrams mentioned above). The UML tool 100 has a design diagram area 101 in which a designer can generate the design diagram 101a representative of the UML. Action code 102a which is associated with the design diagram 101a can be displayed and edited in the action code area 102. The action code may be C++ as is shown in FIG. 2. Each UML tool has a way of describing the diagrams for internal use by the tool, so that, for example, they can be stored on disk to allow the designer to return later and restart where they left off. Such a diagram description is proprietary, but most UML tools also allow a diagram description to be saved in XMI format. There will normally be a (long) sequence of tags that is used to describe the elements of the diagram. The principal elements, for subsequent HL coding, aren't the shapes or positions of lines, containers or other structures in the UML drawing itself, but the elements necessary to actually produce HL code using the process shown in FIG. 1 or FIG. 1a. For example, as described above in connection FIG. 1a, from a class diagram it is necessary to extract attribute and method names and relationships between classes.

The XMI syntax is just a collection of tags and associated values. In XMI, a tag is a sequence of tokens (other than <and>) bounded by the tokens <and >. For example, <Foundation.Core.StructuralFeature.type> is a tag containing the sequence of tokens Foundation.Core.StructuralFeature.type. A token is a printable character (strictly an ASCII character in the range 32 to 126 which includes alpha-numeric characters and others such as %, $, * and the space character).

The start of a diagram description is shown by the presence of an appropriate tag to indicate that what follows (over a possibly large sequence of tags) is a diagram description. This large sequence of tags gives information that can be extracted for that diagram by the parser block 4. The sequences of expected tokens are different for each of the UML diagram types and each diagram is parsed separately following the identification of the initial token.

For a particular UML tool, there is a list of possible token sequences that can make up a tag's contents. The list of token sequences that the parser 4 expects to find depends on the possible sequences that can be produced by the UML tool and is therefore tool dependent.

For example, in the XMI produced by ArgoUML (a popular open source package), the definition of the name of a class, attribute or method has the following format. <Foundation.Core.ModelElement.name>B1</Foundation.Core.ModelElement.name>

The parser 4, 54 finds an expected token sequence and extracts a value associated with that token sequence. For example, if the XMI input document parses the token <Foundation.Core.Association . . . > then the parser will expect that the next token describes a value of the association connector.

The parser 4, 54 may also identify errors in syntax. In the preceding example, it could identify that the association description is incomplete. An association is a relationship between two classes and an association description is complete if both classes are defined, but is incomplete if any one or both of the classes are not present in the description. This could arise because the class relationship has not been properly defined in the corresponding diagram. The parser can issue a warning to the effect that the association has no terminating classes.

The parser 4, 54 expects to locate certain predetermined sequences of tokens within the XMI document and is able to complete a structured data format by extracting predetermined information associated with each located, predetermined sequence of tokens. The structured data contains a number of fields that are completed during the parsing process. In identifying the token sequences, the parser 4 performs a series of pattern matching operations on the XMI input.

FIG. 2A illustrates a portion of an XMI document produced from the UML tool of FIG. 2. The portion relates to a UML class diagram illustrated in FIG. 2B (shown for information only). There are five ‘modules’ 22, 24, 26, 28, 30 to the code. The module 22 is for the class ‘sender’. The module 24 is for the class ‘consumer’. The module 26 is for the interface ‘provider’. The module 28 is for the association relationship and the module 30 is for the abstraction relationship.

It will be apparent to those skilled in the art that that module 22 for the class ‘sender’ has an initial tag 221A defining an identifier ‘xmi.2’ 222 and a terminating tag 221B. The class definition is between the tags 221A and 221B. Within the class definition, a pair of tags 222A, 222B define the class name. The value 223 of the name is located between the tags 222A, 222B. Within the class definition, a pair of tags 224A, 224B define class attributes. Each attribute is identified by a value 225 between its own pair of tags 226A, 226B. Within the class definition, a pair of tags 227A, 227B define methods. Each method is identified by a value 228 between its own pair of tags 229A, 229B.

The module 24 similarly uses tags to define, for the class, an identifier as value 241, a name as value 242 and an attribute value 243 but no methods are defined.

The module 28 uses tags to define an association between the classes ‘sender’ and ‘consumer’ using the values 281, 282.

The module 30 uses tags to define an abstraction association between the classes ‘sender’ and ‘consumer’ using the values 281, 282.

The module 26 uses tags to define, for the interface, an identifier as value 261, a name as value 262 and a method value 263.

During the parsing process, the parser 4, 54 uses a search mask to identify the appropriate tags, in order, and then extracts required values. The parser extracts the value 222 ‘xmi.2’, the value 223 ‘sender’, the value 225 ‘send’ and the value 228 ‘SendData’ from block 22, the value ‘xmi.14’ 241, the value ‘consumer’ 242 and the value ‘receive’ 243 from block 24, the value ‘xmi.21’ 261, the value ‘provider’ 262 and the value ‘SendData’ 263 from block 26, the value ‘xmi.2’ 281 and ‘xmi.14’ 282 from block 28 and the value ‘xmi.2’ and ‘xmi.21’ from block 30.

A syntax error in the UML document 2, 52 can be detected by the parser 4, 54 when the parser finds a token sequence that is not on an allowed list of (possible) token sequences. An error message can be given back to the user in the context of the UML diagram itself and is consequently user-friendly.

FIG. 3 illustrates an example of a structured data format (Parsed XMI) 6 used in the embodiment of FIG. 1. This contains information extracted from the input XMI document 2 illustrated in FIG. 2A. The parsed XMI has a standard output.

The values extracted from a method are placed in a predetermined order, namely, the order identifier value, name value, attribute(s) value(s) (if any) and method name(s) (if any). The identifier value and name values are preceded by a ‘class’ label. The attribute(s) value(s) (if any) are preceded by a ‘attribute’ label. The method name(s) value(s) (if any) are preceded by a ‘method’ label.

The structured data format (parsed XMI) 6 is a terse rendition, with a predetermined format and syntax, of the original XMI document 2.

The principal structured data formats that can be generated by the XMI parser are datatypes, stereotypes, classes, class relationships, interfaces, attributes, methods/functions and state machines. The format of the parsed XMI is necessarily of a predetermined general form, so that the next stage (the transformation) can be applied in an HL-specific manner.

The input to the transformation block 8 is the parsed XMI 6 and the output is HL code 12.

In the embodiment of the invention according to FIG. 1, templates 10 appropriate to the HL language are loaded into the transformation block 8. A set of templates, particular to the target HL, is used to perform pattern matches against the entries in the parsed XMI code 6.

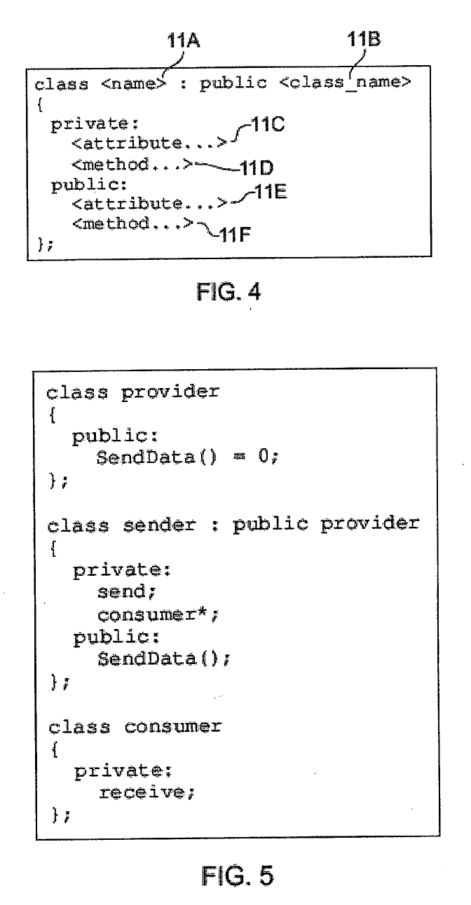

The HL templates are frameworks for generating syntactically correct HL output. A portion of a template 10 is illustrated in FIG. 4. A template 10 is a section of HL code, but with a number of blank fields 11 that need to be filled in by the transformation process.

The transformation process works through the parsed XMI file 6 looking for entries that match one of the HL templates. Once a match has been established between a section of the parsed XMI file 6 and a template, the section of the XMI code is used to populate the blank fields 11 of that template.

For example, in the SystemC SLDL, a line in the parsed XMI file 6 that begins with the keyword ‘class’ will match the ‘class’ template. Once the appropriate template has been determined, the transformation process is aware that the missing fields 11 in the template need to be filled in. The filling of the blank fields 11 is a pattern matching process. The filling of fields is not a simple one-to-one mapping, as, for example, the number of attributes, methods and relationships belonging to a class is not fixed.

The transformation will use the template for a class once the entry ‘class’ is found in the parsed XMI file. The parsed XMI can then be searched to find the class's attributes and methods, but relationships (such as the association) may only be found elsewhere in the parsed XMI file. Note that in FIG. 3, when the association for the class ‘xmi.2’ is found, the second class involved in the association (here ‘xmi.14’) may not be currently known to the transformation process.

In completing the template for a class, information is extracted from the parsed XMI 6 in order to provide the attributes and methods, as well as relationships to other classes, such as associations or inheritance (abstraction). Conditional statements and other such constructs, which help in defining the display of certain entities, may also be present in a template. As an example of the process, FIG. 5 illustrates the results of applying SystemC SLDL templates to each class and interface in the parsed XMI code 6 illustrated in FIG. 3.

As an illustration of the operation, the process of producing SystemC SLDL code from a set of templates and parsed XMI 6 involves using a computer system to:

a) Identify label ‘class’ in XMI code 6 (FIG. 3). The values associated with this class will be used to help populate a template.

b) Access the appropriate template (here the SystemC ‘class’ template) (FIG. 4).

The XMI document holds values within a predetermined structure in a predetermined order, namely, the order identifier value, name value, attribute(s) value(s) (if any) and method name(s) (if any). The identifier value and name values are preceded by a ‘class’ label. The attribute(s) value(s) (if any) are preceded by a ‘attribute’ label. The method name(s) value(s) (if any) are preceded by a ‘method’ label.

c) Populate the <name> field 11A in the class template with the name value (e.g. sender) following the class label of the current class (e.g. xmi.2).

d) Populate the <class_name> field 11B with the name value (e.g. provider) following the identifier value (e.g. xmi.21), that itself follows the identifier value of the current class (xmi.2) and the abstraction label.

e) Populate the private <attribute> field 11C with the attribute values (e.g. send) following the attribute label of the current class (e.g. xmi.2).

f) Populate the private <method> field 11D with the method values following the method label of the current class (e.g. xmi.2).

g) Populate the private <method> field 11D with the name value (e.g. consumer) following the identifier value (e.g. xmi.14), that itself follows the identifier value of the current class (xmi.2) and the association label.

h) Populate the public <attribute> field 11E with the attribute values of the class identified in <class_name> and populate the public <method> field 11F with the method values of the class identified in <class_name>.

It will be understood by those skilled in the art how these general principals may be further extended to allow the coding of HL code. Depending on the template type, a field could be one of many possible constructs, including interfaces, behaviors, channels, class names, attributes, methods, relationships and variables.

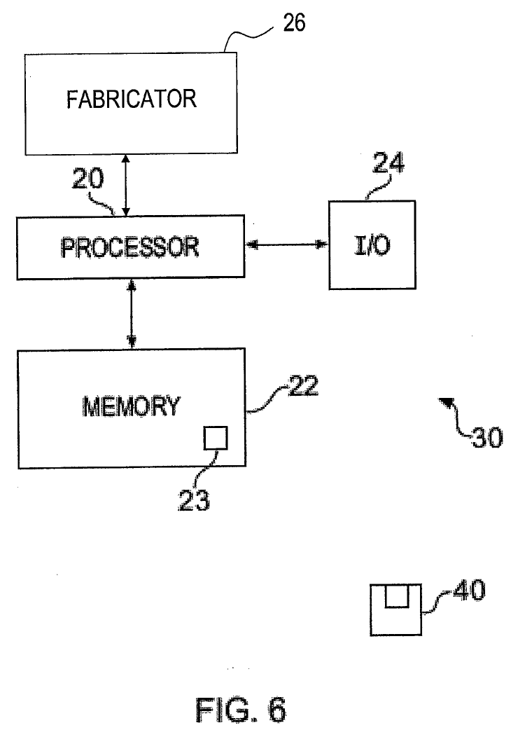

The translator 1 illustrated in FIG. 1 or 1a may be implemented in hardware or software. FIG. 6 shows a software implementation in which a computer system 30 uses computer program instructions 23 to operate as a translator.

The computer system 30 comprises a central processing unit 20 and a memory 22. The processor 20 is arranged to write to and read from the memory 22. The processor 20 is also arranged to provide outputs signals to input/output port 24 and to receiving input signals from the same port. The memory 22 stores computer program instructions 23 that control the operation of the computer 30 when loaded into the processor 20. The computer program instructions 23 provide the logic and routines that enables the electronic device to perform the parsing block 4 functionality and the transformation block 8 functionality. The memory 22 also stores templates 10.

The XMI input document 2 can be received by the processor via the I/O port 24, or any other equivalent means, such as on a carrier or by transfer across a data network, and the HL code may be provided as output by the processor 20 from the I/O port 24.

The processor 20 is further connected to a circuit fabricator 26 which receives the HL code and fabricates an integrated circuit based on the HL code which has been generated automatically by the processor 20 from the XMI symbolic description 2.

The computer program instructions may arrive at the computer via an electromagnetic carrier signal or be copied from a physical entity 40 such as a computer program product, a memory device or a record medium such as a CD-ROM or DVD.

Although embodiments of the present invention have been described in the preceding paragraphs with reference to various examples, it should be appreciated that modifications to the examples given can be made without departing from the scope of the invention as claimed.

The explanation which follows details some of the particular features already described, along with additional features, and terminology of the method and translator of the present invention.

### UML Class Diagrams

Class diagrams are used in the UML model to define the interface to each class of objects in a design, to specify the properties of each class, and to define the relationships between classes. The interface to each class is specified in terms of public UML operations and properties. Public operations can be called by other objects, and public attributes can be read and written from other objects. Object interfaces are event-based rather than continuously assigned. Relationships between classes, such as associations, compositions, realizations and generalizations/specializations, can also be defined in the class diagram. The present invention employs two stereotypes in the XMI input document structure 2, 52, both of which can be applied to attributes. The <<input> and <<output>> stereotypes mark an attribute as an input or output of the whole design. Input attributes are read-only.

### UML State Machine Diagrams

State machine diagrams provide an event-based model of object behavior. States and transitions can include actions/activities written in C++, i.e. as action code in the UML. A state machine can use operation calls to trigger its own transitions. The translator and method of the present invention supports actions on transitions, state entry and state exit, as well as “do activities” which occur continually while in a particular state.

### UML Object Diagrams

While class diagrams define the properties of a complete class of objects, Object diagrams are used to specify the properties of individual object instances. Object diagrams are used where explicit instantiation is needed.

### UML C++ Subset (Action Language)

The C++ subset used as the action language code in the UML in one embodiment of the present invention, includes the following constructs:—
primitive types: bool, char, short, int, long;
most operators;
arrays of primitive types;
control constructs: for, while, do-while, if-else, return; and
method calls.

The C++ subset also has a language extension, namely the addition of a wait( ) function, which can be used for explicit scheduling by the transformation block during scheduling to generate extra states.

### Source-Level Debugging and Profiling

Support for design verification is essential for hardware design tools. There are several ways in which a UML-derived hardware design might be simulated and debugged in the context of the present invention. The approach differs depending on whether the debugging target is the HDL design or the system-level model of the hardware. When debugging an HDL design, the design is loaded into an external HDL simulator, and the simulation can be controlled by a UML-aware debugger using a programming interface. There are several common programming interfaces, which let other applications interface with a running hardware simulation—examples include VPI/PLI, FLI and VHPI. These programming interfaces would let the UML hardware debugger control the execution of the simulation, for example by starting and stopping simulation. The debugger could also examine the contents of the simulated hardware data storage elements such as registers and memories. A UML-aware hardware debugger could thus wrap around the HDL simulator, and automatically translate between the HDL and UML views of the design. In this way, the user could see a UML-based source-level view of the design, while the simulation is performed at the HDL level. This could extend to the analysis of UML variables and properties, and the setting of breakpoints and watchpoints in the UML source. For this to be possible, the behavioral synthesis process must record some debugging information—essentially recording which hardware constructs correspond to which UML constructs. When the debugging target is a system-level model, similar techniques could be used, however rather than interfacing a hardware simulator, the UML debugger could either interface a software debugger, or else add instrumentation to the system-level model code, so that the UML debugger can directly interface with the system-level model.

### Profiling

A profiler analyses the performance of a design, in particular with relation to performance bottlenecks. The HDL designs could be profiled via a hardware simulator. In the context of the present invention, a UML-aware hardware profiler could use a hardware simulator to identify which pieces of hardware are active at each point in time, as well as recording which tasks each piece of hardware is performing. As in the case of UML-level debugging, the hardware simulator could be controlled through a programming interface such as VPI. The resulting log could be converted by the profiler from the hardware level to the UML source level, where it would help the user identify and understand hardware performance bottlenecks. The profiling results might include information such as which UML operations are active for the largest percentage of the simulation time, or how much time a UML state machine spends in a particular state. When the translator of the present invention outputs an ESL language such as SystemC, a UML profiling tool could wrap around a conventional software profiling tool, and translate the ESL profiling results back to the UML source language.

### Constraints

In the context of the present invention, constraints are useful for two different reasons. Firstly, they can be used to direct the synthesis process so that it produces hardware designs with particular properties. Secondly, constraints can be used for the verification of designs. UML has a dedicated constraint language called OCL (Object Constraint Language). Alternatively, constraints could be written directly into the action language code.

Time constraints are commonly used in synthesis to ensure that the hardware can function at the desired clock speed. When performing behavioral synthesis it is also possible to constrain the throughput of the hardware. It is also possible to constrain other aspects of the design, for example the hardware resource requirements.

When constraints are used for design verification, the constraints at the UML level are propagated through to the target language, where they can be evaluated during simulation. For example, a UML constraint implemented through the method and translator of the present invention could be converted to C++ assert statements in the hardware level language, such as SystemC, or to a hardware verification language such as OpenVera which could be used together with the RTL hardware description during simulation.

### Structural and Behavioral Hardware Descriptions

Conventional graphical hardware design entry systems use a schematic representation of the design. The individual modules and connections in the design are explicitly instantiated. In contrast, UML was originally designed for the representation of software, and there is not necessarily a direct correspondence between the elements of a UML model and the hardware components used to represent them. This is useful early in the design process, as it lets the designer concentrate on the relationships between objects, rather than the specific hardware implementation of those relationships. However, the designer has less control over the final form of the hardware. UML version 2 includes the ability to specify hardware designs in a structural manner, using composite structure diagrams. Composite structure diagrams are a variation of class diagrams, which include a structural description of the class contents. Composite structure diagrams can include elements such as ports, parts and connectors. In the context of the systems described in the present application, two uses of composite structure diagrams are possible: they could either be used to describe some parts of the design in a structural fashion, while other parts of the design might be specified using other UML elements, or else the composite structure diagrams might describe a structural view of a design which is specified elsewhere in a behavioral style. In the latter case, the composite structure diagram would essentially be a piece of extra annotation which would cause the UML synthesis tool to choose a particular favored hardware architecture.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of automatically translating modeling language code to hardware language code comprising:
parsing the modeling language code to extract values associated with predetermined ones of a plurality of constructs to generate parsed modeling language code; and
applying a transformation block to the parsed modeling language code,
wherein the transformation block is adapted to convert the parsed modeling language code into hardware language code.

2. A method as claimed in claim 1, further comprising the step of converting the parsed modeling language code into intermediate language code.

3. A method as claimed in claim 2, wherein the modeling language code comprises class code representative of characteristics and/or variables of data which are to be processed and action code representative of methods performed on the data.

4. A method as claimed in claim 3, wherein the step of parsing comprises identifying the class code and the action code.

5. A method as claimed in claim 4, further comprising converting the action code to a low-level language which is compiled into a section of the intermediate language code.

6. A method as claimed in claim 5, wherein the low-level language is an assembly language.

7. A method as claimed in claim 3, wherein the action code is a high-level language, such as C++.

8. A method as claimed in claim 3, wherein the class code is parsed to generate a data structure in the intermediate language code comprising the extracted values tagged with predetermined labels in a compiled form.

9. A method as claimed in claim 1, further comprising generating a section of the hardware language directly from the modeling language code.

10. A method as claimed in claim 9, wherein the step of parsing comprises identifying one or more structural aspects of hardware represented in the modeling language code and the step of generating a section of the hardware language comprises generating a section of hardware language directly from the one or more identified structural aspects.

11. A method as claimed in claim 10, wherein the structural aspects represented in the modeling language comprise one or more features residing in: class diagrams, object diagrams, deployment diagrams, composite structure diagrams, components diagrams and/or stereotypes.

12. A method as claimed in claim 3, further comprising the step of generating action code for behavioral diagrams represented in the modeling language code and subsequently converting the action code corresponding to the behavioral diagrams into the intermediate language code.

13. A method as claimed in claim 3, comprising converting code representative of behavioral diagrams represented in the modeling language code directly into the intermediate language code without conversion into the action code.

14. A method as claimed in claim 1, wherein the transformation block populates, in a predetermined manner using the extracted values, empty fields of one or more predetermined templates wherein the or each template comprises code of the hardware language.

15. A method as claimed in claim 14, wherein parsing comprises:
identifying a diagram definition within the modeling language code;
identifying predetermined constructs associated with the identified diagram definition; and
extracting values associated with the identified predetermined constructs.

16. A method as claimed in claim 15, wherein a construct is a predetermined token sequence.

17. A method as claimed in claim 15, wherein the identified predetermined constructs are a predetermined subset of the possible constructs of the identified diagram definition.

18. A method as claimed in claim 14, wherein the output of the parsing stage has a standard output format having a predetermined structure and order.

19. A method as claimed in claim 18, wherein parsing creates a data structure comprising the extracted values in a predetermined order, placed in predetermined positions relative to predetermined labels.

20. A method as claimed in claim 19, wherein the predetermined order of extracted values includes identifier, name, attributes and method names.

21. A method as claimed in claim 20, wherein the identifier and name values are preceded by a ‘class’ label.

22. A method as claimed in claim 21, wherein the attributes values are preceded by a ‘attribute’ label.

23. A method as claimed in claim 22, wherein the method names values are preceded by a ‘method’ label.

24. A method as claimed in claim 19, wherein the populating stage comprises:
identifying a first one of a plurality of predetermined labels;
loading a template comprising code of the hardware language with empty fields that is dependent on the identity of the first label; and
populating the fields of the loaded template in a predetermined manner using the labels of the data structure to locate an extracted value for populating a field.

25. A method as claimed in claim 24, wherein the loaded template is a class template and the extracted values provide the class attributes and methods, as well as relationships to other classes, such as associations or inheritance.

26. A method as claimed in claim 1, wherein the extracted values relate at least to class names, attributes, methods, associations and abstractions.

27. A method as claimed in claim 1, wherein parsing additionally checks the syntax of the modeling language code.

28. A method as claimed in claim 1, wherein the modeling language code is object-oriented.

29. A method as claimed in claim 1, wherein the modeling language code is XMI.

30. A method as claimed in claim 1, wherein the modeling language is UML.

31. A method as claimed in claim 1, wherein the modeling language is SysML.

32. A method as claimed in claim 1, wherein the hardware language code is a hardware description language, such as VHDL or Verilog.

33. A method as claimed in claim 1, wherein the hardware language code is a system level design language, such as SystemC.

34. A method as claimed in claim 1, comprising determining the structure of an electronic circuit from the hardware language code and fabricating the electronic circuit comprising circuit components.

35. A computer-program product comprising computer executable instructions to perform the steps of claim 1.

36. A code translator for automatically translating modeling language code to hardware language code the translator comprising:
a parsing block adapted to parse the modeling language code to extract values associated with predetermined ones of a plurality of constructs; and
a transformation block adapted to convert the parsed modeling language code into hardware language code.

37. A code translator as claimed in claim 36, further comprising a compiler block adapted to covert the parsed modeling language code into intermediate language code.

38. A code translator as claimed in claim 37, wherein the modeling language code comprises class code representative of characteristics and/or variables of data which are to be processed and action code representative of methods performed on the data.

39. A code translator as claimed in claim 38, wherein the parsing block is configured to distinguish the class code from the action code.

40. A code translator as claimed in claim 38, wherein the action code is a high-level action language, such as C++.

41. A code translator as claimed in claim 39, further comprising an action code transformation block configured to convert the action code to a low-level language which is compiled into a section of the intermediate language.

42. A code translator as claimed in claim 36, wherein the transformation block is further adapted to populate, in a predetermined manner using the extracted values, empty fields of one or more predetermined templates wherein the or each template comprises code of the hardware language.

43. A code translator as claimed in claim 36, wherein the parsing block is adapted to:
identify a diagram definition within the modeling language code;
identify predetermined constructs associated with the identified diagram definition; and
extract values associated with the identified predetermined constructs.

44. A code translator as claimed in claim 36, wherein the transformation block is adapted to:
identify a first one of a plurality of predetermined labels;
load a template comprising code of the hardware language with empty fields that is dependent on the identity of the first label; and
populate the fields of the loaded template in a predetermined manner using the labels of the data structure to locate an extracted value for populating a field.

45. Apparatus comprising the code translator of claim 36 and a circuit fabricator adapted to determine the structure of an electronic circuit corresponding to the hardware language code from the hardware language code and fabricate the electronic circuit.

46. A record medium embodying a computer program having computer program instructions executable for:
parsing modeling language code to extract values associated with predetermined ones of a plurality of constructs; and
converting the parsed modeling language code to hardware language code.

47. A record medium as claimed in claim 46, comprising instructions executable for converting the parsed modeling language code into the intermediate language.

48. A record medium as claimed in claim 47, wherein the modeling language code comprises class code representative of characteristics and/or variables of data which are to be processed and action code representative of methods performed on the data.

49. A record medium as claimed in claim 48, wherein the parsing instruction distinguishes the class code from the action code.

50. A record medium as claimed in claim 49, further comprising instructions executable to transform the action code to a level-level action language which is subsequently compiled into a section of the intermediate language.

51. A record medium as claimed in claim 46, wherein the converting instructions comprise instructions for populating, in a predetermined manner using the extracted values, empty fields of one or more predetermined templates wherein the or each template comprises code of the hardware language.

52. A method of automatically translating modeling language code to hardware language code comprising:
parsing the modeling language code to extract values associated with predetermined ones of a plurality of constructs; and
populating, in a predetermined manner using the extracted values, empty fields of one or more predetermined templates wherein the or each template comprises code of the hardware language.

53. A code translator for automatically translating modeling language code to hardware language code the translator comprising:
a parsing block for parsing the modeling language code to extract values associated with predetermined ones of a plurality of constructs; and
a transformation block for populating, in a predetermined manner using the extracted values, empty fields of one or more predetermined templates wherein the or each template comprises code of the hardware language.

54. A record medium embodying a computer program having computer program instructions for:
parsing the modeling language code to extract values associated with predetermined ones of a plurality of constructs; and
populating, in a predetermined manner using the extracted values, empty fields of one or more predetermined templates wherein the or each template comprises code of the hardware language.
